(19) United States
(12) Patent Application Publication
(10) Pub. No.: US 2024/0395048 A1
(43) Pub. Date: Nov. 28, 2024

(54) SYSTEM AND METHOD FOR DETECTING AND ANALYZING CONSUMER TRANSACTIONS TO PROVIDE LIST OF SELECTED OBJECTS

(71) Applicant: ATAI LABS PRIVATE LIMITED, Hyderabad (IN)

(72) Inventors: KRISHNA KISHORE ANDHAVARAPU, HYDERABAD (IN); SIDDARTHA PENDYALA, KARIMNAGAR (IN); LOVARAJU ALLU, VISAKHAPATNAM (IN); SRIKAR REDDY VUNDI, HYDERABAD (IN); SATISH CHANDRA GUNDA, KURNOOL (IN); KISHOR ARUMILLI, HYDERABAD (IN); GANGADHAR GUDE, HYDERABAD (IN)

(21) Appl. No.: 18/691,614

(22) PCT Filed: Sep. 12, 2022
(86) PCT No.: PCT/IB2022/058576

§ 371 Date: Mar. 13, 2024

(30) Foreign Application Priority Data
Sep. 14, 2021 (IN) 202141041270

(51) Int. Cl. G06V 20/52; G06Q 30/0601; G06V 10/25; G06V 10/74; G06V 40/20

(52) U.S. Cl. CPC G06V 20/52; G06Q 30/0633; G06V 10/25; G06V 10/761; G06V 40/28; G06V 2201/07

(57) ABSTRACT

A system for detecting and analyzing consumer transactions to provide selected list of objects, comprising first camera and second camera configured to monitor and to capture first camera feed and second camera feed, first camera feed and second camera feed comprising consumer transaction images of consumer transactions performed by consumers in front of display shelf, consumer transaction identifying module configured to receive first camera feed and second camera feed, pre-processor module configured to compare consumer transaction images and sends consumer transaction images to location finder module, location finder module configured to detect hand positions and computes physical location information of hand within display shelf using triangulation technique; direction detection module configured to identify direction of motion of hand with physical location information, direction detection module configured to enabling visual object detection module on consumer transaction images to detect objects in the hand and provides selected list of objects to consumer.

### TECHNICAL FIELD

The disclosed subject matter relates generally to a consumer action analysis. More particularly, the system and method for detecting and analyzing consumer transactions to provide list of selected objects.

### BACKGROUND

Generally, a display shelf fills with different types of objects are arranged similarly in fashion to a retail store, and all the units of a particular type of objects are placed together in a bounded area within the display shelf. The objects include, but are not limited to, products, items, goods, articles, things, commodities, merchandises, supplies, possessions, and so forth. An action of a consumer picking up the object(s) placed on the display shelf in the retail store may indicate that the customer is interested in the object(s), and if the consumer placing the object(s) on the display shelf in the retail store may indicate that the consumer is not interested in the object(s). The object(s) pick-up/placing actions of the consumers are identified by analyzing the objects on the display shelves and is also possible to obtain the objects information in running the retail store. To perform such analysis of object pick-up actions of consumer, it is necessary to observe the behavior of each consumer present in the vicinity of the display shelf and detect the object pick-up actions, and in this regard, conventional image recognition technology to detect object pick-up actions of consumer from the captured images of an area around the display shelf. But, image recognition technology unable to perform detecting and analyzing consumer transactions.

In the light of the aforementioned discussion, there exists a need for a system for detecting and analyzing consumer transactions to provide list of selected objects.

### SUMMARY

The following presents a simplified summary of the disclosure in order to provide a basic understanding of the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a system and method for detecting and analyzing consumer transactions to provide list of selected objects.

An objective of the present disclosure is directed towards the system that eliminates spurious contours occur due to lighting changes, shadows, or image decoding errors by observing the distribution of the contours in the difference map.

Another objective of the present disclosure is directed towards the system that uses uniform and diffused illumination through-out the region.

Another objective of the present disclosure is directed towards using statistical properties of the detected contours in the difference map between successive frames to discard false positives.

Another objective of the present disclosure is directed towards using uniform background and distributed lighting conditions to discard false positives.

Another objective of the present disclosure is directed towards the system that eliminates the majority of the false positives by augmenting the current approach with a homographic method like finding the wrist position using pose estimation, optical flow and so forth.

Another objective of the present disclosure is directed towards generating a homographic transformation between calculated values and actual values to correct errors.

In an embodiment of the present disclosure, the system comprising a first camera and a second camera configured to monitor and to capture a first camera feed and a second camera feed, the first camera feed and the second camera feed comprising one or more images of one or more consumer transactions performed by one or more consumers in front of a display shelf comprising one or more objects.

In another embodiment of the present disclosure, the first camera and the second camera configured to transmit the first camera feed and the second camera feed to a computing device over a network, the computing device comprising a consumer transaction identifying module configured to receive the first camera feed and the second camera feed from the first camera and the second camera over the network.

In another embodiment of the present disclosure, the consumer transaction identifying module comprising a pre-processor module configured to save the one or more consumer transaction images of the one or more consumer transactions performed by the consumer in front of the display shelf.

In another embodiment of the present disclosure, the pre-processor module configured to compare the one or more consumer transaction images and send the one or more consumer transaction images to a location finder module.

In another embodiment of the present disclosure, the location finder module configured to detect one or more hand positions from the one or more consumer transaction images captured by the first camera and the second camera and computes a physical location information of the one or more objects within the display shelf using a triangulation technique;

In another embodiment of the present disclosure, a direction detection module configured to identify a direction of motion of the hand from the one or more consumer transaction images.

In another embodiment of the present disclosure, the direction detection module configured to enable a visual object detection module on the one or more consumer transaction images to detect the one or more objects in the hand; and

In another embodiment of the present disclosure, a central database configured to receive the first camera feed and the second camera feed captured by the first camera and the second camera during the one or more consumer transactions performed in front of the display shelf by the one or more consumers.

In another embodiment of the present disclosure, the central database configured to hold the essential information of one or more objects, the information of objects includes, dimensions, images, price, placement within the shelf and so forth. The central database configured to interact with consumer transaction identifying module to display the selected list of objects along with quantities.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1A is a diagram depicting a front view of the display shelf, in accordance with one or more exemplary embodiments.

FIG. 1B is a diagram depicting the second camera view of the display shelf, in accordance with one or more exemplary embodiments.

FIG. 1C is an example diagram depicting an actual region information required to analyse and triangulate an exact location of the objects in real world coordinates, in accordance with one or more exemplary embodiments.

FIG. 1D is an example diagram depicting a schematic representation of a system with various measurements, in accordance with one or more exemplary embodiments.

FIG. 1E is an example diagram depicting the measurement of racks with in the display shelf, in accordance with one or more exemplary embodiments.

FIG. 1F is an example diagram depicting the measurements of various components of the physical setup needed to compute the physical location, in accordance with one or more exemplary embodiments.

FIG. 1G is an example diagram depicting the second camera's field of view, resolution and pixel location of the hand to calculate the value of θ_x by using the properties of triangles.

FIG. 2A and FIG. 2B are diagram depicting a schematic representation of the marking regions for the first camera and the second camera, in accordance with one or more exemplary embodiments.

FIG. 2C is an example diagram depicting the consumer transaction, in accordance with one or more exemplary embodiments.

FIG. 2D is another example diagram depicting the before consumer transaction and after consumer transaction, in accordance with one or more exemplary embodiments.

FIG. 2E is another example diagram depicting the pose estimation, in accordance with one or more exemplary embodiments.

FIG. 3 depicts a schematic representation of the system for monitoring and detecting consumer transactions to provide list of selected objects, in accordance with one or more exemplary embodiments.

FIG. 4 is a block diagram depicting a schematic representation of consumer transaction identifying module shown in FIG. 4, in accordance with one or more exemplary embodiments.

FIG. 5 is an example flow diagram depicting a method of pre-processor module, in accordance with one or more exemplary embodiments.

FIG. 6 is another example of flow diagram depicting a method for location finder module, in accordance with one or more exemplary embodiments.

FIG. 7 is an example diagram depicting an actual location information and predicted locations to compute homography, in accordance with one or more exemplary embodiments.

FIG. 8 is another example of flow diagram depicting a method for direction detection module, in accordance with one or more exemplary embodiments

FIG. 9 is another example of flow diagram depicting a method for detecting and analyzing consumer transactions to provide list of selected objects, in accordance with one or more exemplary embodiments.

FIG. 10 is a block diagram illustrating the details of digital processing system in which various aspects of the present disclosure are operative by execution of appropriate software instructions.

Furthermore, the objects and advantages of this invention will become apparent from the following description and the accompanying annexed drawings.

### REFERENCE NUMERALS IN THE DRAWINGS

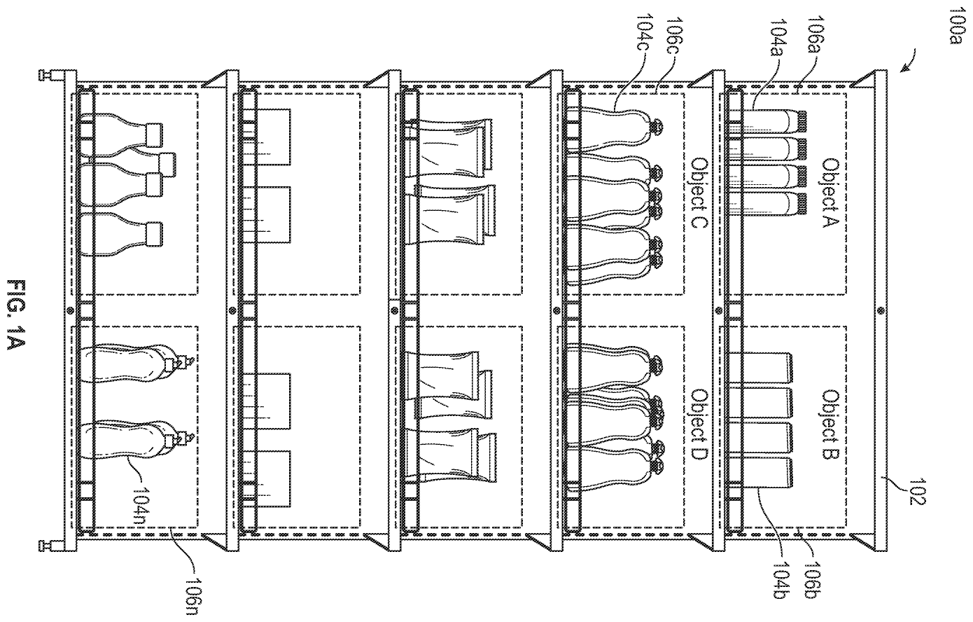

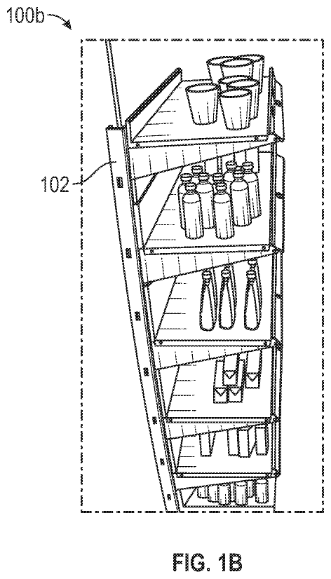

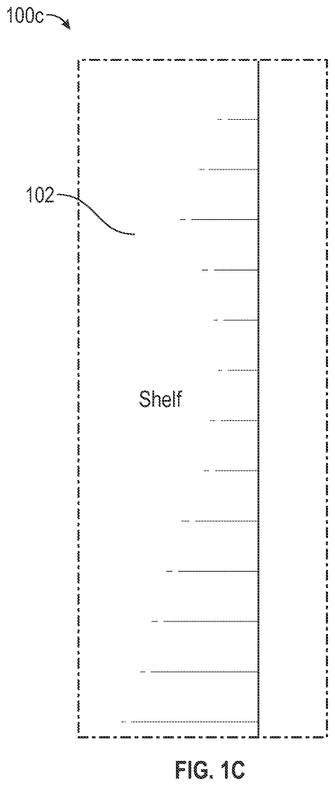

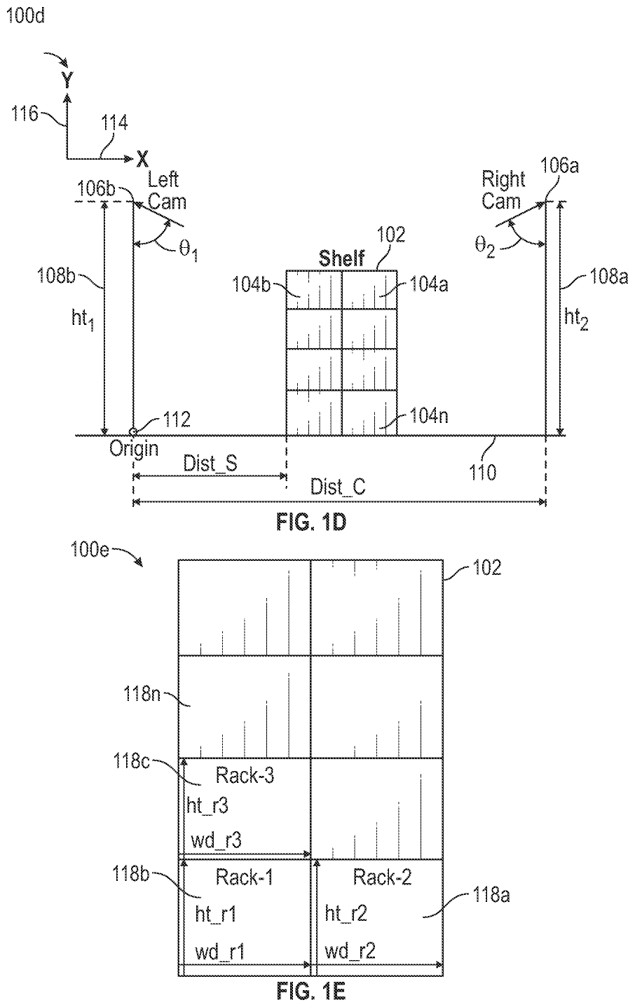

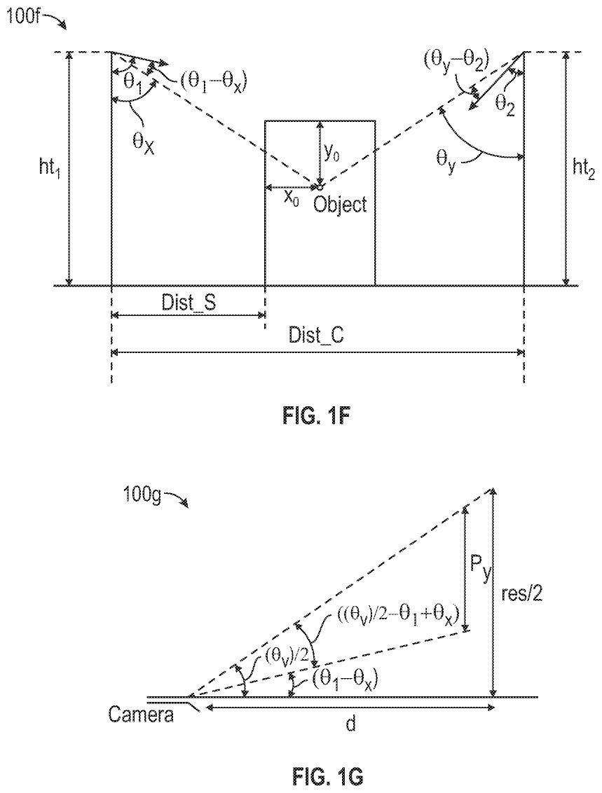

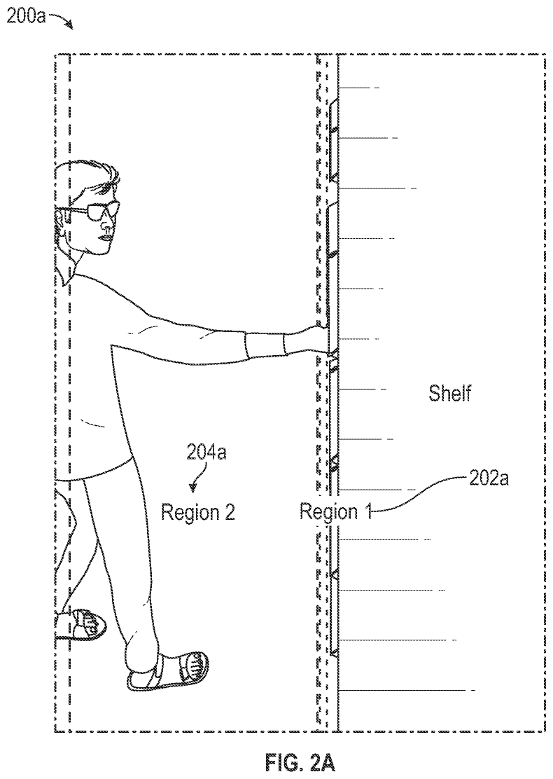

FIG. 1A is a diagram depicting a front view of the display shelf, in accordance with one or more exemplary embodiments.

### 102 Display Shelf

### 104a, 104b, 104c, . . . and 104n Objects

### 105a, 105b, . . . and 105n Marked Locations

FIG. 1B is a diagram depicting the second camera view of the display shelf, in accordance with one or more exemplary embodiments.

102 Display shelf
106b Second camera (Not Shown)

FIG. 1C is an example diagram depicting an actual region information required to analyse and triangulate an exact location of the objects in real world coordinates.

102 Display shelf

FIG. 1D is an example diagram depicting a schematic representation of a system with various measurements.

### 106a Right Camera

### 106b Left Camera

### 108a Right Side Height

### 108b Left Side Height

### 110 Floor

### 112 Origin

### 114 X-axis

### 116 Y-axis

FIG. 1E is an example diagram depicting the measurement of racks with in the display shelf.

### 102 Display Shelf

### 118a, 118b, 118c, . . . and 118n Racks

### 104a, 104b, 104c, . . . and 104n Objects

FIG. 1F is an example diagram depicting the measurements of various components of the physical setup needed to compute the physical location.

FIG. 1G is an example diagram depicting the second camera's field of view, resolution and pixel location of the hand to calculate the value of θ_x by using the properties of triangles.

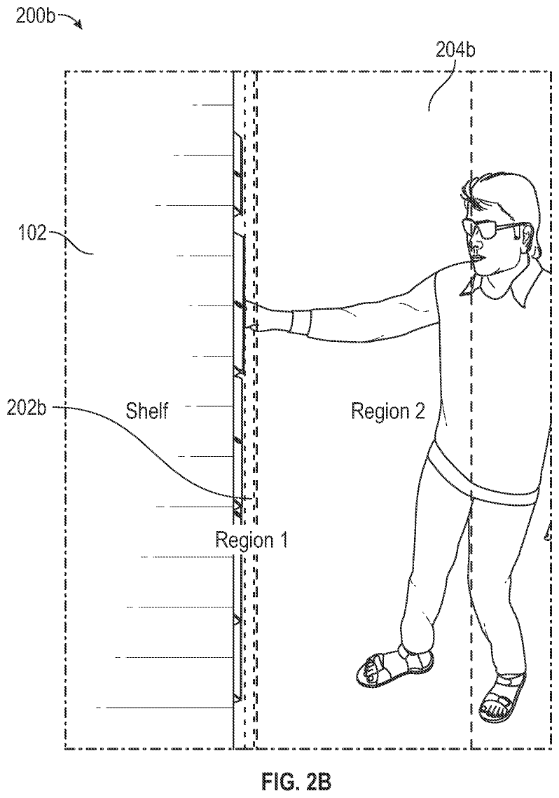

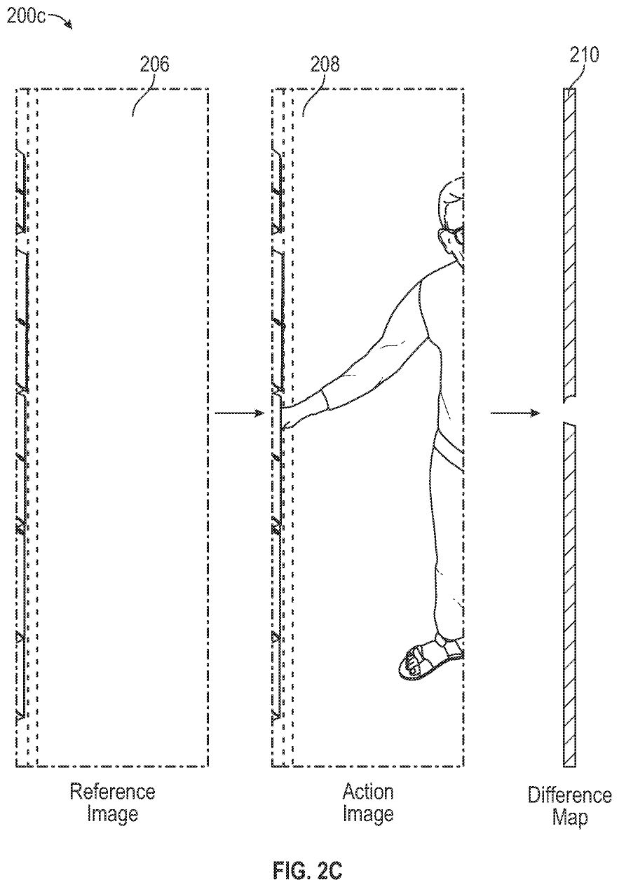

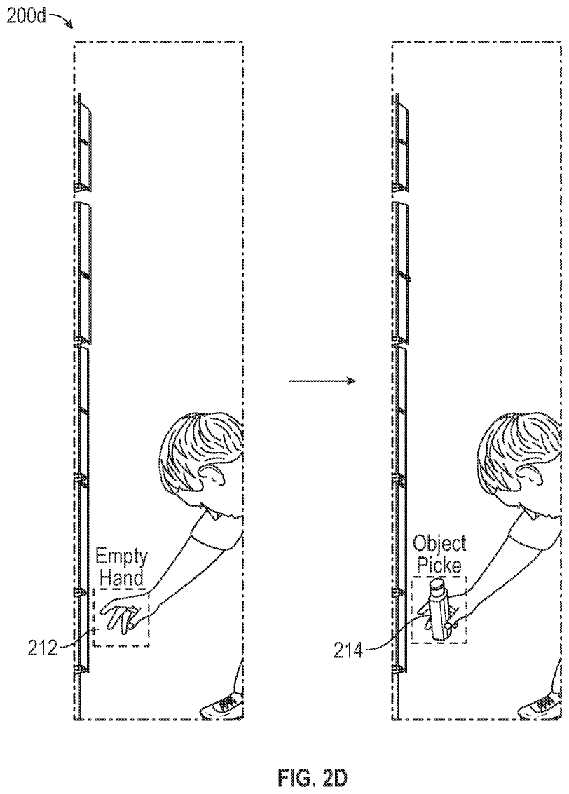

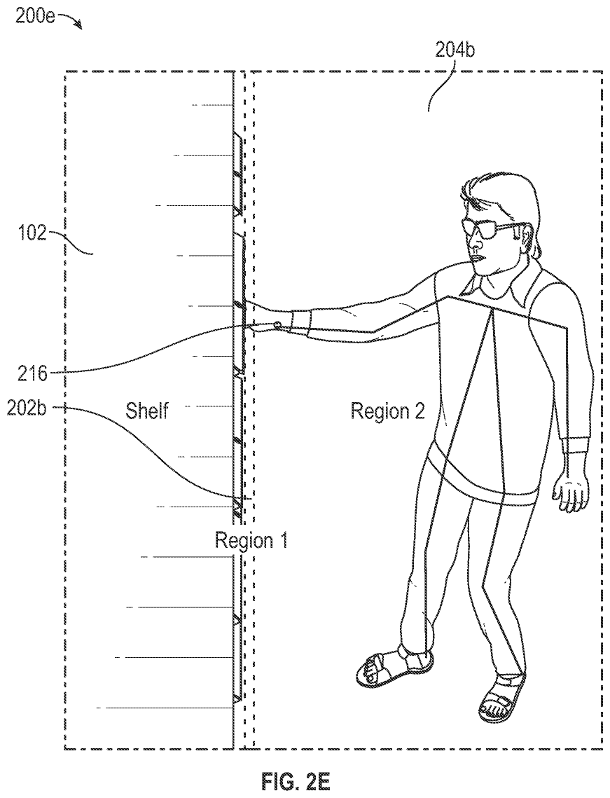

FIG. 2A and FIG. 2B are diagram depicting a schematic representation of the marking regions for the first camera and the second camera.

### 202a First Right Marking Region

### 204a Second Right Marking Region

### 202b First Left Marking Region

### 204b Second Left Marking Region

FIG. 2C is an example diagram depicting the consumer transaction.

### 206 Reference Image

### 208 Consumer Action

### 210 Difference Map

FIG. 2D is another example diagram depicting the before consumer transaction and after consumer transaction.

212 Hand Movement before Consumer Transaction
214 Hand Movement after Consumer Transaction

FIG. 2E is another example diagram depicting the pose estimation, in accordance with one or more exemplary embodiments.

### 216 Band

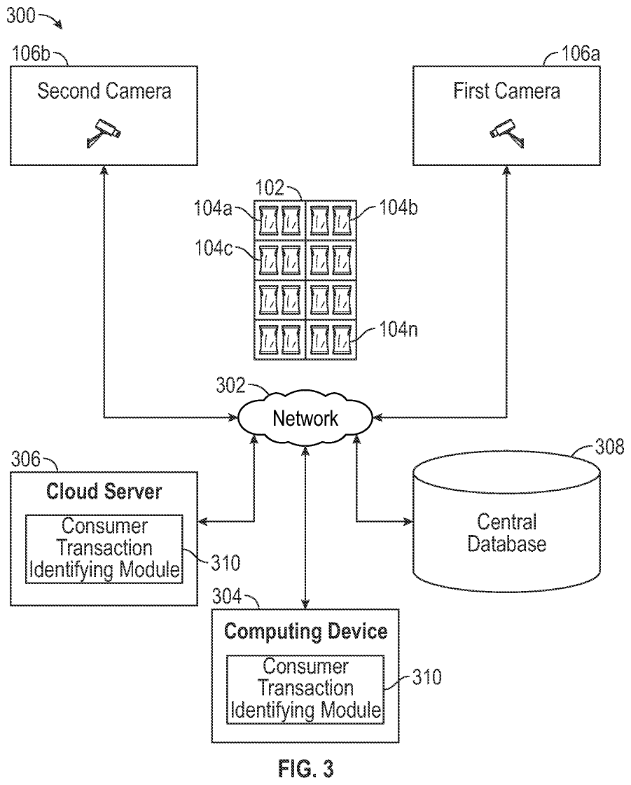

FIG. 3 depicts a schematic representation of the system for monitoring and detecting consumer transactions to provide list of selected objects.

### 102 Display Shelf

### 104a, 104b, 104c, . . . and 104n Objects

### 106a Right Camera

### 106b Left Camera

### 302 Network

### 304 Computing Device

### 308 Cloud Server

### 308 Central Database

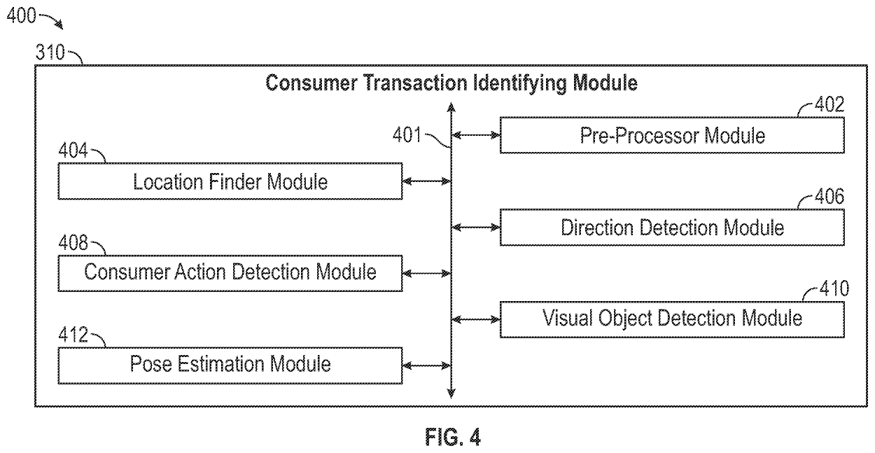

FIG. 4 is a block diagram depicting a schematic representation of consumer transaction identifying module 310 shown in FIG. 4.

### 401 Bus

### 402 Pre-Processor Module

### 404 Location Finder Module

### 406 Direction Detection Module

### 408 Consumer Action Detection Module

### 410 Visual Object Detection Module

### 412 Pose Estimation Module

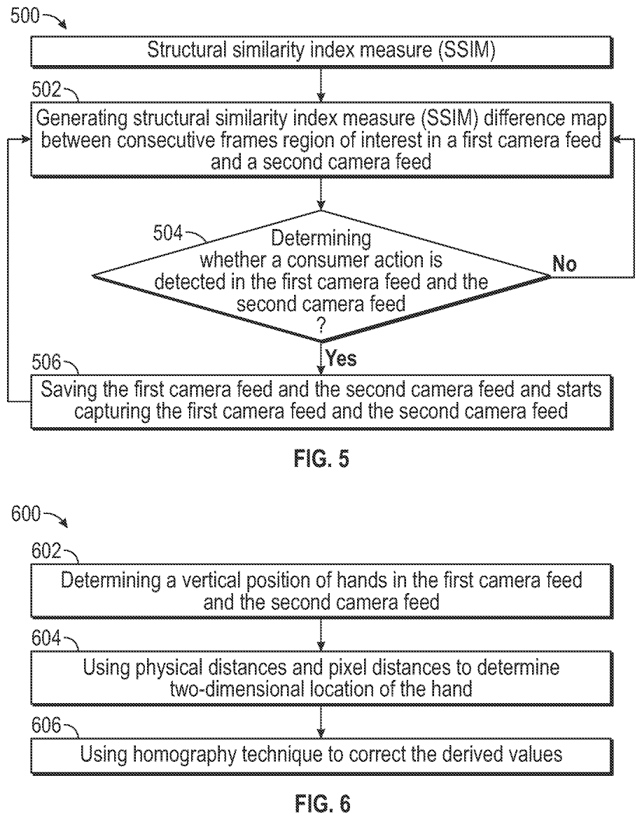

FIG. 5 is an example flow diagram depicting a method of pre-processor module.

502 Generating structural similarity index measure (SSIM) difference map between consecutive frames region of interest in the first camera feed and the second camera feed
504 Determining whether the consumer action is detected in the first camera feed and the second camera feed?,
504 is Yes, 506 Saving the first camera feed and the second camera feed and starts capturing the first camera feed and the second camera feed, Further, the method reverts at step 502.
504 is No, the method reverts at step 502

FIG. 6 is another example of flow diagram depicting a method for location finder module.

602 Determining the vertical position of hands in the first camera feed and the second camera feed
604 Using physical distances and pixel distances to determine 2-Dimensional location of the hand
606 Using homography transformation to correct the derived values

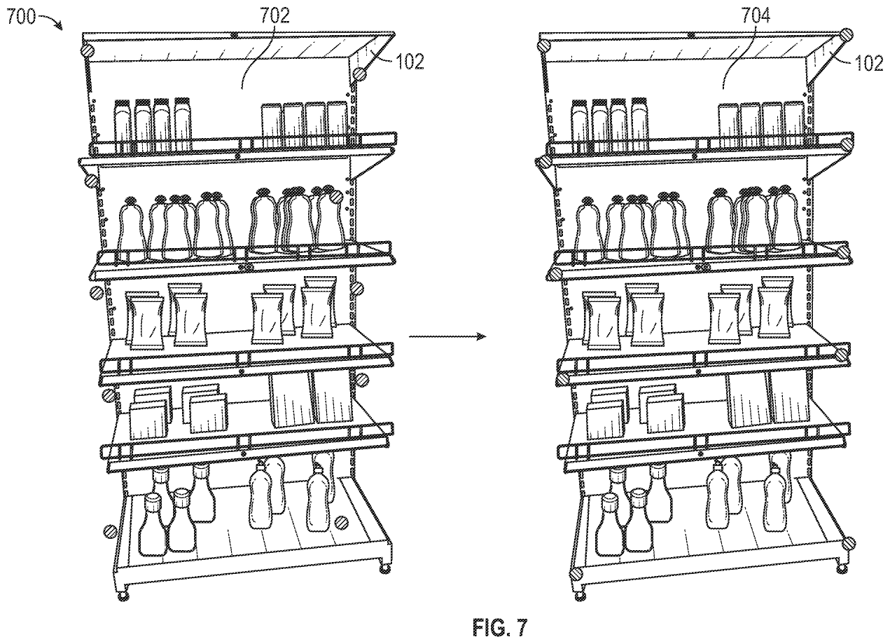

FIG. 7 is an example diagram depicting actual location information and predicted locations to compute homography.

### 102 Display Shelf

### 702 Predicted Locations of the Objects

### 704 Actual Locations of the Objects

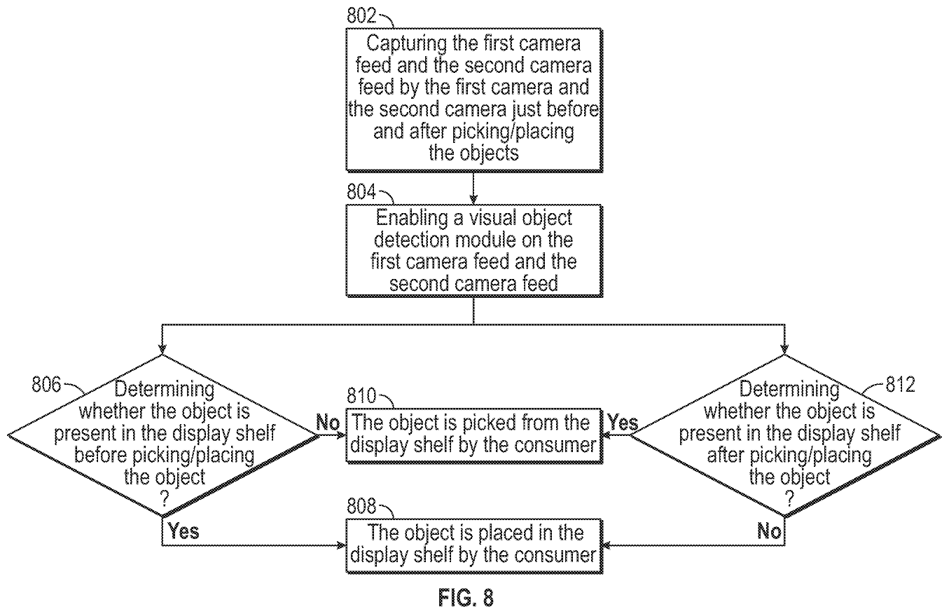

FIG. 8 is another example of flow diagram depicting a method for direction detection module.

802 capturing the first camera feed and the second camera feed by the first camera and the second camera just before and after picking/placing the objects

804 Enabling the visual object detection module on the first camera feed and the second camera feed
806 Determining whether the object is present in the display shelf before picking/placing the object?
806 is Yes, 808 The object is placed in the display shelf by the consumer
806 is No, 810 The object is picked from the display shelf by the consumer
804, the method continues at step 812, Determining whether the object is present in the display shelf after picking/placing the object?
812 is Yes, the method continues at step 806
812 is No, the method continues at step 808

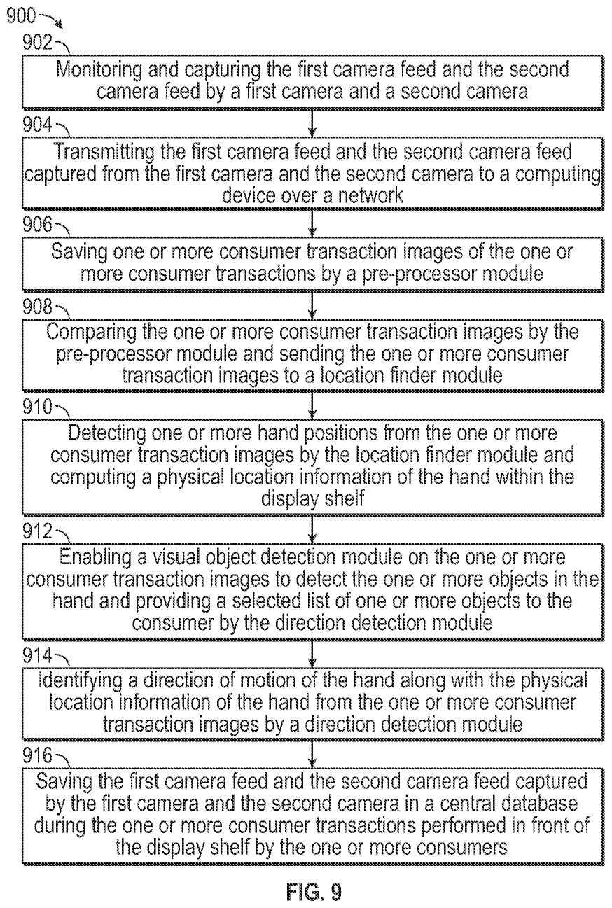

FIG. 9 is another example of flow diagram depicting a method for detecting and analyzing consumer transactions to provide list of selected objects.

902 monitoring and capturing a first camera feed and a second camera feed by a first camera and a second camera, the first camera feed and the second camera feed comprising one or more consumer transaction images.
904 transmitting the first camera feed and the second camera feed captured from the first camera and the second camera to a computing device over a network.
906 saving the one or more consumer transaction images of the one or more consumer transactions by a pre-processor module.
908 comparing the one or more consumer transaction images by the pre-processor module and sending the one or more consumer transaction images to a location finder module.
910 detecting one or more hand positions from the one or more consumer transaction images by the location finder module and computing a physical location information of the hand within the display shelf using a triangulation technique.
912 enabling a visual object detection module on the one or more consumer transaction images to detect the one or more objects in the hand and providing a selected list of one or more objects to the consumer by the direction detection module.
914 identifying a direction of motion of the hand along with the physical location information of the hand from the one or more consumer transaction images by a direction detection module.
916 saving the first camera feed and the second camera feed captured by the first camera and the second camera in a central database during the one or more consumer transactions performed in front of the display shelf by the one or more consumers.

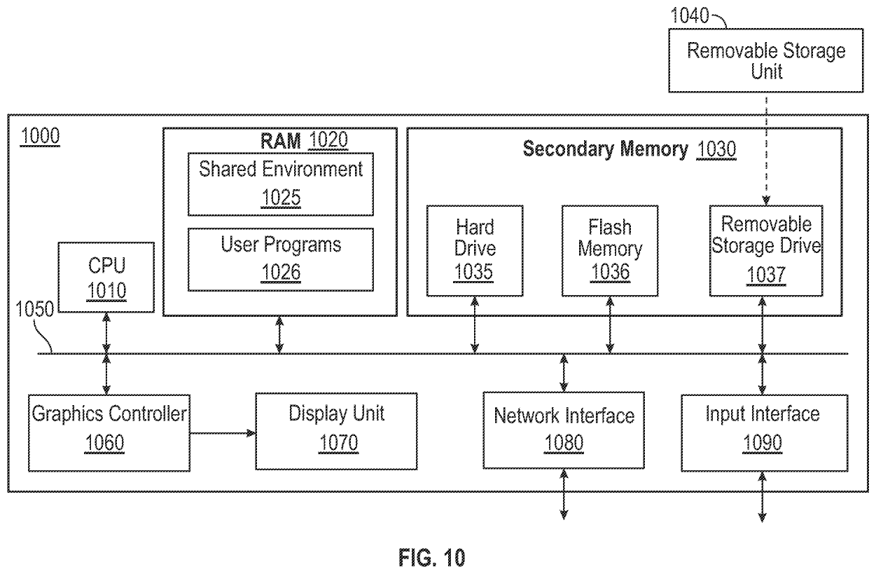

FIG. 10—digital processing system corresponds to the computing device

### 1010 CPU

### 1020 Random Access Memory (RAM)

### 1025 Shared Environment of RAM 1020

### 1026 User Programs of RAM 1020

### 1030 Secondary Memory

1035 Hard Drive of secondary Memory 1030
1036 Flash Memory of secondary Memory 1030
1037 Removable Storage Drive of secondary Memory 1030

### 1040 Removable Storage Unit

### 1050 Communication Path

### 1060 Graphics Controller

### 1070 Display Unit

### 1080 Network Interface

### 1090 An Input Interface

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

Referring to FIG. 1A, FIG. 1A is a diagram 100a depicting a front view of the display shelf, in accordance with one or more exemplary embodiments. The front view of the display shelf 100a includes a display shelf 102, objects 104a, 104b, 104c . . . and 104n, and marked locations 105a, 105b . . . and 105n. The objects 104a, 104b, 104c . . . and 104n may include, but not limited to, object A, object B, object C, object D, object E, object F, object G, object H, object I, object J . . . object N. The arrangement of the objects 104a, 104b, 104c . . . and 104n in the display shelf 102 and the marked locations 105a, 105b . . . and 105n which are considered to determine the object type. Each object may be positioned in a designated space within the display shelf 102. A first camera 106a and a second camera 106b (shown in FIG. 3) may be configured to recreate the virtual shelf using the marked locations 105a, 105b . . . and 105n. The display shelf 102 may be placed between the first camera 106a and the second camera 106b. The first camera 106a may be positioned on right side to the display shelf 102. The second camera 106a may be positioned on left side to the display shelf 102. The first camera 106a and the second camera 106b may be positioned on either side of the display shelf 102 such that the line passing perpendicularly through the center of the lens falls in the plane of the display shelf face. In another embodiment, the first camera 106a and the second camera 106b may be positioned a little higher than the height of the display shelf 102 and facing the display shelf 102 at an angle so as to have the complete vertical height of the display shelf 102.

Referring to FIG. 1B, FIG. 1B is a diagram 100b depicting the second camera view of the display shelf, in accordance with one or more exemplary embodiments. The second camera view of the display shelf 100b includes the display shelf 102, and the second camera 106b (shown in FIG. 3).

Referring to FIG. 1C, FIG. 1C is an example diagram 100c depicting an actual region information required to analyze and triangulate an exact location of the objects 104a, 104b, 104c . . . 104n in real world coordinates, in accordance with one or more exemplary embodiments. The diagram 100c includes the display shelf 102. The region of the display self-102 may be graying out using computer vision techniques to indicate that the display shelf 102 do not provide any valuable information regarding the object 104a or 104b or 104c or . . . 104n being picked.

Referring to FIG. 1D, FIG. 1D is an example diagram 100d depicting a schematic representation of a system with various measurements, in accordance with one or more exemplary embodiments. The schematic representation of the system 100d includes the display shelf 102, objects 104a, 104b, 104c . . . and 104d, the right camera 106a and the left camera 106b, right side height 108, left side height 108b, a floor 110, an origin 112, x-axis 114 and y-axis 116. The base of the left camera 106a may be considered as the origin 112 for all measurements. The measurements may include, measuring the distance of the first camera 106a and the second camera 106b from the origin 112 in both x-axis 114 and y-axis 116, measuring the direction along the floor 110 and in the plane of the open face of the display shelf 102 is considered as x-axis 114, perpendicularly upward direction is considered to be y-axis 116, measuring the height of the first camera 106a and the second camera 106b with respect to the defined origin 112 and the angle with respect to the y-axis 116.

Referring to FIG. 1E, FIG. 1E is an example diagram 100e depicting the measurement of racks with in the display shelf, in accordance with one or more exemplary embodiments. The diagram 100e includes the display shelf 102, racks 118a, 118b, 118c, . . . and 118n, objects 104a, 104b, 104c, . . . and 104n. Each rack 118a/118b/118c . . . 118n may be assumed to contain the same type of objects 104a, 104b, 104c, . . . and 104n. In other words, the racks 118a, 118b, 118c, . . . and 118n may not have a physical separation but the boundary between any two types of objects 104a, 104b, 104c, . . . and 104n may be considered as rack separation. Hence the racks 118a, 118b, 118c, . . . and 118n may not be symmetrical.

Referring to FIG. 1F, FIG. 1F is an example diagram 100f depicting the measurements of various components of the physical setup needed to compute the physical location, in accordance with one or more exemplary embodiments.

Referring to FIG. 1G, FIG. 1G is an example diagram 100g depicting the second camera's field of view, resolution and pixel location of the hand to calculate the value of θ_x by using the properties of triangles. To calculate the value of θ_x by using the properties of triangles. Using the second camera's 106b field of view, resolution and pixel location of the hand. Further, θ_y may be computed similarly using the frame from the first camera 106a field of view. The location of the object may be computed with respect to the top left corner of the shelf by knowing all other measurements. This can be performed as shown by equations below.

Referring to FIG. 2A and FIG. 2B, FIG. 2A and FIG. 2B are diagram 200a and 200b depicting a schematic representation of the marking regions for the first camera and the second camera, in accordance with one or more exemplary embodiments. The camera positioned on the left side may be the second camera 106b and the camera positioned on the right side may be the first camera 106a. The diagram 200a depicts a first right marking region 202a, a second right marking region 204a. The diagram 200b depicts a first left marking region 202b and a second left marking region 204b. The first camera 106a and the second camera 106b (shown in FIG. 3) may be defined with the regions of interests (RoIs). The region of interests may include the first right marking region 202a, a second right marking region 204a, the first left marking region 202b, and the second left marking region 204b. The first right marking region 202a and the first left marking region 202b may be configured to monitor the movement of hand while picking or placing the object 104a or 104b or 104c or . . . 104n. The second right marking region 204a and the second left marking region 204b may be used by a visual object detection module to detect whether the object 104a or 104b or 104c or . . . 104n is picked or placed back.

Referring to FIG. 2C, FIG. 2C is an example diagram 200c depicting the consumer transaction, in accordance with one or more exemplary embodiments. The diagram 200c includes a reference image 206, a consumer action 208, and a difference map 210. With the uniform illumination, difference is seen only when there is some movement perpendicular to the display shelf 102 (consumer's hand movement). The exact vertical position of the hand in the difference map 210 is obtained by using the computer vision techniques like thresholding and finding the contours of appropriate size. The consumer transactions may include moving the empty hand inside the display shelf 102 and taken out without picking any object 104a or 104b or 104c or . . . 104n, moving the empty hand inside the display shelf 102 and picks the object 104a or 104b or 104c or . . . 104n, in this case the object 104a or 104b or 104c or . . . 104n has to be added to the consumer bill, moving the hand with the object inside the display shelf 102 to put back inside the display shelf 102 and empty hand comes out, moving the hand with the object 104a or 104b or 104c or . . . 104n inside the display shelf 102 to put back inside the shelf but isn't placed back and hand comes out with the object 104a or 104b or 104c or . . . 104n), picking the object 104a or 104b or 104c or . . . 104n from the display shelf 102 or placing the object 104a or 104b or 104c or . . . 104n back in the display shelf 102.

Referring to FIG. 2D, FIG. 2D is another example diagram 200d depicting the before consumer transaction and after consumer transaction, in accordance with one or more exemplary embodiments. The diagram 200d depicts a hand movement before consumer transaction 212, a hand movement after consumer transaction 214. The hand movement before the consumer transaction 212 may be performed by a consumer to pick the object 104a or 104b or 104c or . . . 104n from the display shelf 102. The hand movement after the consumer transaction 214 may include the object 104a or 104b or 104c or . . . 104n in the hand of the consumer. The consumer may include, but not limited to, a customer, a buyer, a purchaser, a shopper, and so forth.

Referring to FIG. 2E, FIG. 2E is another example diagram 200e depicting the pose estimation, in accordance with one or more exemplary embodiments. The diagram 200e depicts a band 216. The majority of the false positives by augmenting the current approach with a homographic method like finding the wrist position using pose estimation, optical flow and so forth. The deep learning technique may be used to perform the pose estimation. Performing such processing on the above images generates output similar to the FIG. 2E. Using the vicinity of the wrist to the band 216 (region 1) to determine the approximate pixel location of the hand while picking up the object.

Referring to FIG. 3, FIG. 3 is a block diagram 300 representing a system in which aspects of the present disclosure can be implemented. Specifically, FIG. 3 depicts a schematic representation of the system for monitoring and detecting consumer transactions to provide list of selected objects, in accordance with one or more exemplary embodiments. The system 300 includes the display shelf 102, the objects 104a, 104b, 104c . . . and 104n, the first camera 106a, the second camera 106b, a network 302, a computing device 304, a cloud server 306, and a central database 308. The computing device 304 includes a consumer transaction identifying module 310. The consumer transaction identifying module 310 may be configured to analyze the consumer transactions performed by the consumer in front of the display shelf 102. The first right camera 106a, the second camera 106b may include, but is not limited to, three-dimensional cameras, thermal image cameras, infrared cameras, night vision cameras, varifocal cameras, and the like. The hand positions may include, but not limited to, hand movements. The central database 308 may be configured to hold the essential information of one or more objects, the information of objects includes, dimensions, images, price, placement within the shelf and so forth. The central database 308 may also be configured to interact with consumer transaction identifying module to display the selected list of objects along with quantities. The cloud server 306 may include a processor and memory, which may store or otherwise have access to the consumer transaction identifying module 310, which may include or provide image processing (e.g., for consumer identification, object counting, and/or object identification), and/or location determination.

The network 302 may include, but is not limited to, an Ethernet, a wireless local area network (WLAN), or a wide area network (WAN), a Bluetooth low energy network, a ZigBee network, a Controller Area Network (CAN bus), a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and the like without limiting the scope of the present disclosure.

Although the computing device 304 as shown in FIG. 3, an embodiment of the system 300 may support any number of computing devices. The system 300 may support only one computing device. The computing device 304 may include, but are not limited to, a desktop computer, a personal mobile computing device such as a tablet computer, a laptop computer, or a netbook computer, a smartphone, a server, an augmented reality device, a virtual reality device, a digital media player, a piece of home entertainment equipment, backend servers hosting database and other software, and the like. Each computing device 304 supported by the system 300 is realized as a computer-implemented or computer-based device having the hardware or firmware, software, and/or processing logic needed to carry out the intelligent messaging techniques and computer-implemented methodologies described in more detail herein.

Referring to FIG. 4, FIG. 4 is a block diagram 400 depicting a schematic representation of a consumer transaction identifying module 310 shown in FIG. 4, in accordance with one or more exemplary embodiments. The consumer transaction identifying module 310 includes a bus 401, a pre-processor module 402, a location finder module 404, and a direction detection module 406, a consumer action detection module 408, a visual object detection module 410, and a pose estimation module 412. The bus 401 may include a path that permits communication among the modules of the consumer transaction identifying module 310. The term “module” is used broadly herein and refers generally to a program resident in the memory of the computing device 304.

The pre-processor module 402 may be configured to capture the first camera feed and second camera feed as an input and saves the consumer transaction images of consumer transactions performed by the consumer. The first camera feed and the second camera feed may include, but not limited to, captured images of the consumer transactions using the first camera 106a and the second camera 106b, hand position images, and hand movement images, and so forth.

The pre-processor module 402 may be configured to handle scenarios where the consumer's hand moves inside the display shelf 102 but nothing is picked or placed back. The first camera feed and the second camera feed may be continuously monitored in independent threads. In each thread, consecutive frames from one of the first camera 106a or the second camera 106b are compared to find any movement of the hand near the display shelf 102. However, the entire image is not considered for comparison. The first right marking region 202a and/or the first left marking region 202b from two consecutive frames are compared and the difference is computed using computer vision methods, for example, structural similarity index measure (SSIM). The structural similarity index measure difference map sometimes may show spurious contours even without much change in the scene. This may be due to lighting changes, shadows, or image decoding errors. In such scenarios, there is a need to identify a difference in the first right marking region 202a and/or the first left marking region 202b though there is no physical movement.

The false positives from the consumer transactions may be filtered using a combination of consumer transaction detection techniques based on the physical environment. The consumer transaction identifying module 310 may be programmed with the consumer transaction detection techniques. The consumer transaction detection techniques may include, using the reference frame to compare with the current frame. The reference frame is periodically updated during idle conditions at regular intervals. Hand presence in the first right marked region 202a and/or first left marked region 202b is detected as long as there is a difference between the reference frame and the current frame. It is possible that the difference might not be significant if the background color is very similar to the skin tone of the consumer. One of the ways to avoid such scenarios is by laying a uniform, non-reflective, and single colored (typically not matching the skin color) material in all the locations in the first right marking region 202a and/or the first left marking region 202b of the first camera 106a and the second camera 106b field of view.

According to an exemplary embodiment of the present disclosure, the consumer transaction identifying module 310 may include a deep learning technique or pose estimation module 412 configured to perform pose estimations to determine the position of the wrist while picking/placing the object 104a or 104b or 104c or . . . 104n. This wrist position from the multiple camera views (for example, the first camera and the second camera) may be used to triangulate the real-world coordinates. The first right marking region 202a and/or the first left marking region 202b may use the vicinity of the wrist to determine the approximate pixel location of the hand while picking up the object 104a or 104b or 104c or . . . 104n.

The consumer transactions in the first right marking region 202a and/or the first left marking region 202b are computed from both the first camera 106a and the second camera 106b. The consumer transactions are passed to the location finder module 404 to determine the physical location of the hand or object 104a or 104b or 104c or . . . 104n within the display shelf 102. The location finder module 404 may be configured to receive the hand positions from both the first camera 106a and the second camera 106b as input and computes the physical location of the hand within the display shelf 402 by using trigonometric operations.

The central database 308 may be configured to receive the first camera feed and the second camera feed captured by the first camera 106a and the second camera 106b during the consumer transactions. The first camera feed and the second camera feed may be passed to the direction detection module 406.

The pre-processor module 402 and the location finder module 404 may provide the location information of the object/hand. The direction detection module 406 may be configured to identify the direction of motion of the hand as well as the location information from the first camera feed and the second camera feed. The direction detection module 406 may be configured to identify the direction of motion of the hand as well as the location information whether the object 104a or 104b or 104c or . . . 104n is picked. The first camera feed and the second camera feed captured by the pre-processor module 402 may be transmitted to the direction detection module 406. The direction detection module 406 may include the visual object detection module 410. The visual object detection module 410 may be a neural network trained to detect object 104a or 104b or 104c or . . . 104ns in the hand. The visual object detection module 410 may be trained with the relevant object images to recognize the product during the consumer transactions. The direction detection module 406 may be configured to receive the cropped images of the second right marked region 202b and the second left marked region 204b from the first camera 106a and the second camera 106b. The direction detection module 406 may be configured to detect the object 104a or 104b or 104c or . . . 104n in at least one of the cameras.

The location of the object 104a or 104b or 104c or . . . 104n may be computed with respect to the top left corner of the display shelf 102. The generated results are prone to errors due to various reasons. The reasons for few major issues that cause inconsistency in results may include, the computations assume pin-hole camera assumption and hence relative sizes of the objects 104a, 104b, 104c . . . 104n are retained in images. However, in practice, all the cameras have barrel distortion which changes the object 104a or 104b or 104c or . . . 104n dimensions as the customer moves away from the centre. It is not possible to correct the distortion completely and hence results in a slight error in a computed location with respect to an actual location, the hand location is computed assuming that the hand moves exactly perpendicular to the shelf and centre of hand approximates the location of the object 104a or 104b or 104c or . . . 104n. There may be a slight error in computed results when this assumption fails. There may also be errors accumulated due to measurement errors while measuring various distances and angles. These errors are corrected to some extent by using a homography transformation to map the computed values to a different plane. This homography transformation is computed using a triangulation technique as mentioned below:

Simulate the movement near the four corners of the display shelf 102 and compute the locations using the location finder module 404. Using computer vision methods to transform the computed locations to the actual values to identify the physical measurements of the display shelf 102. This homography transformation may be applied to all other points as a post-processing step to account for the errors. The triangulation technique may be configured to generate the homographic transformation between calculated values and actual values to correct errors.

Referring to FIG. 5, FIG. 5 is an example flow diagram 500 depicting a method of pre-processor module, in accordance with one or more exemplary embodiments. The method 500 may be carried out in the context of the details of FIG. 1A, FIG. 1B, FIG. 1C, FIG. 1D, FIG. 1E, FIG. 1F, FIG. 1G, FIG. 2A, FIG. 2B, FIG. 2C, FIG. 2D, FIG. 3, and FIG. 4. However, the method 500 may also be carried out in any desired environment. Further, the aforementioned definitions may equally apply to the description below.

The method commences at step 502, generating the structural similarity index measure (SSIM) difference map between consecutive frames region of interest in the first camera feed and the second camera feed. Determining whether the consumer action is detected in the first camera feed and the second camera feed? at step 504. If the answer at step 504 is YES, saving the first camera feed and the second camera feed and starts capturing the first camera feed and the second camera feed, at step 506. Thereafter at step 506, the method reverts at step 502. If the answer at step 504 is NO, the method reverts at step 502.

Referring to FIG. 6, FIG. 6 is another example of flow diagram 600 depicting a method for location finder module, in accordance with one or more exemplary embodiments. The method 600 may be carried out in the context of the details of FIG. 1A, FIG. 1B, FIG. 1C, FIG. 1D, FIG. 1E, FIG. 1F, FIG. 1G, FIG. 2A, FIG. 2B, FIG. 2C, FIG. 2D, FIG. 3, FIG. 4, and FIG. 5. However, the method 600 may also be carried out in any desired environment. Further, the aforementioned definitions may equally apply to the description below.

The method commences at step 602, determining the vertical position of hands in the first camera feed and the second camera feed. Using physical distances and pixel distances to determine the 2-Dimensional location of the hand, at step 604. Using homography transformation to correct the derived values, at step 606.

FIG. 7 is an example diagram depicting actual location information and predicted locations to compute homography, in accordance with one or more exemplary embodiments. The diagram 700 depicts the display shelf 102, predicted locations of the objects 702, and actual locations of the objects 704. The actual locations of the objects 704 may be the display shelf image captured by the first camera 106a and the second camera 106b. The predicted locations of the objects 702 may be the predicted locations of the image of the object in the display shelf obtained by performing the triangulation technique.

Referring to FIG. 8, FIG. 8 is another example of flow diagram 800 depicting a method for direction detection module, in accordance with one or more exemplary embodiments. The method 800 may be carried out in the context of the details of FIG. 1A, FIG. 1B, FIG. 1C, FIG. 1D, FIG. 1E, FIG. 1F, FIG. 1G, FIG. 2A, FIG. 2B, FIG. 2C, FIG. 2D, FIG. 3, FIG. 4, FIG. 5, FIG. 6, and FIG. 7. However, the method 800 may also be carried out in any desired environment. Further, the aforementioned definitions may equally apply to the description below.

The method commences at step 802, capturing the first camera feed and the second camera feed by the first camera and the second camera just before and after picking/placing the objects. Enabling the visual object detection module on the first camera feed and the second camera feed, at step 804. Determining whether the object is present on the display shelf before picking/placing the object, at step 806. If the answer at step 806 is YES, the object is placed on the display shelf by the consumer, at step 808. If the answer at step 806 is NO, the object is picked from the display shelf by the consumer, at step 810. At step 804, the method continues at step 812, determining whether the object is present on the display shelf after picking/placing the object. If the answer at step 812 is YES, the method continues at step 806. If the answer at step 812 is NO, the method continues at step 808.

Referring to FIG. 9, FIG. 9 is another example of flow diagram 900 depicting a method for detecting and analyzing consumer transactions to provide list of selected objects, in accordance with one or more exemplary embodiments. The method 900 may be carried out in the context of the details of FIG. 1A, FIG. 1B, FIG. 1C, FIG. 1D, FIG. 1E, FIG. 1F, FIG. 1G, FIG. 2A, FIG. 2B, FIG. 2C, FIG. 2D, FIG. 3, FIG. 4, FIG. 5, FIG. 6, FIG. 7, and FIG. 8. However, the method 900 may also be carried out in any desired environment. Further, the aforementioned definitions may equally apply to the description below.

The method commences at step 902, monitoring and capturing the first camera feed and the second camera feed by the first camera and the second camera, the first camera feed and the second camera feed comprising one or more consumer transaction images. Thereafter at step 904, transmitting the first camera feed and the second camera feed captured from the first camera and the second camera to the computing device over the network. Thereafter at step 906, saving the one or more consumer transaction images of the one or more consumer transactions by the pre-processor module. Thereafter at step 908, comparing the one or more consumer transaction images by the pre-processor module and sending the one or more consumer transaction images to the location finder module. Thereafter at step 910, detecting one or more hand positions from the one or more consumer transaction images by the location finder module and computing the physical location information of the hand within the display shelf using the triangulation technique. Thereafter at step 912, enabling the visual object detection module on the one or more consumer transaction images to detect the one or more objects in the hand and providing the selected list of one or more objects to the consumer by the direction detection module. Thereafter at step 914, identifying the direction of motion of the hand along with the physical location information of the hand from the one or more consumer transaction images by the direction detection module. Thereafter at step 916, saving the first camera feed and the second camera feed captured by the first camera and the second camera in the central database during the one or more consumer transactions performed in front of the display shelf by the one or more consumers.

Referring to FIG. 10, FIG. 10 is a block diagram illustrating the details of digital processing system 1000 in which various aspects of the present disclosure are operative by execution of appropriate software instructions. Digital processing system 1000 may correspond to the computing device 304 (or any other system in which the various features disclosed above can be implemented).

Digital processing system 1000 may contain one or more processors such as a central processing unit (CPU) 1010, random access memory (RAM) 1020, secondary memory 1030, graphics controller 1060, display unit 1070, network interface 1080, an input interface 1090. All the components except display unit 1070 may communicate with each other over communication path 1050, which may contain several buses as is well known in the relevant arts. The components of FIG. 10 are described below in further detail.

CPU 1010 may execute instructions stored in RAM 1020 to provide several features of the present disclosure. CPU 1010 may contain multiple processing units, with each processing unit potentially being designed for a specific task. Alternatively, CPU 1010 may contain only a single general-purpose processing unit.

RAM 1020 may receive instructions from secondary memory 1030 using communication path 1050. RAM 1020 is shown currently containing software instructions, such as those used in threads and stacks, constituting shared environment 1025 and/or user programs 1026. Shared environment 1025 includes operating systems, device drivers, virtual machines, etc., which provide a (common) run time environment for execution of user programs 1026.

Graphics controller 1060 generates display signals (e.g., in RGB format) to display unit 1070 based on data/instructions received from CPU 1010. Display unit 1070 contains a display screen to display the images defined by the display signals. Input interface 1090 may correspond to a keyboard and a pointing device (e.g., touch-pad, mouse) and may be used to provide inputs. Network interface 1080 provides connectivity to a network (e.g., using Internet Protocol), and may be used to communicate with other systems (such as those shown in FIG. 3, a network) connected to the network.

Secondary memory 1030 may contain hard drive 1035, flash memory 1036, and removable storage drive 1037. Secondary memory 1030 may store the data software instructions (e.g., for performing the actions noted above with respect to the Figures), which enable digital processing system 1000 to provide several features in accordance with the present disclosure.

Some or all of the data and instructions may be provided on the removable storage unit 1040, and the data and instructions may be read and provided by removable storage drive 1037 to CPU 1010. Floppy drive, magnetic tape drive, CD-ROM drive, DVD Drive, Flash memory, a removable memory chip (PCMCIA Card, EEPROM) are examples of such removable storage drive 1037.

The removable storage unit 1040 may be implemented using medium and storage format compatible with removable storage drive 1037 such that removable storage drive 1037 can read the data and instructions. Thus, removable storage unit 1040 includes a computer readable (storage) medium having stored therein computer software and/or data. However, the computer (or machine, in general) readable medium can be in other forms (e.g., non-removable, random access, etc.).

In this document, the term “computer program product” is used to generally refer to the removable storage unit 1040 or hard disk installed in hard drive 1035. These computer program products are means for providing software to digital processing system 1000. CPU 1010 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 1030. Volatile media includes dynamic memory, such as RAM 1020. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1050. Transmission media can also take the form of acoustic or light waves, such as those generated during radio-wave and infra-red data communications.

In an embodiment of the present disclosure, a system for detecting and analyzing consumer transactions to provide selected list of objects, comprising the first camera and the second camera configured to monitor and to capture the first camera feed and the second camera feed, the first camera feed and the second camera feed comprising one or more consumer transaction images of one or more consumer transactions performed by one or more consumers in front of the display shelf comprising one or more objects.

In another embodiment of the present disclosure, the first camera and the second camera configured to transmit the first camera feed and the second camera feed to the computing device over the network, the computing device comprising the consumer transaction identifying module configured to receive the first camera feed and the second camera feed from the first camera and the second camera over the network.

In another embodiment of the present disclosure, the consumer transaction identifying module comprising the pre-processor module configured to save the one or more consumer transaction images of the one or more consumer transactions performed by the consumer in front of the display shelf, the pre-processor module configured to compare the one or more consumer transaction images and send the one or more consumer transaction images to a location finder module.

In another embodiment of the present disclosure, the location finder module configured to detect one or more hand positions from the one or more consumer transaction images captured by the first camera and the second camera and computes a physical location information of the one or more objects within the display shelf using a triangulation technique.

In another embodiment of the present disclosure, a direction detection module configured to identify a direction of motion of the hand along with the physical location information of the one or more objects from the one or more consumer transaction images, the direction detection module configured to enable a visual object detection module on the one or more consumer transaction images to detect the one or more objects in the hand and provides a selected list of one or more objects to the consumer.

In another embodiment of the present disclosure, a central database configured to receive the first camera feed and the second camera feed captured by the first camera and the second camera during the one or more consumer transactions performed in front of the display shelf by the one or more consumers

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description. CLAIMS

1. A system for detecting and analyzing consumer transactions to provide selected list of objects, comprising:
a first camera and a second camera configured to monitor and to capture a first camera feed and a second camera feed, the first camera feed and the second camera feed comprising one or more images of one or more consumer transactions performed by one or more consumers in front of a display shelf comprising one or more objects, the first camera and the second camera configured to transmit the first camera feed and the second camera feed to a computing device over a network, the computing device comprising a consumer transaction identifying module configured to receive the first camera feed and the second camera feed from the first camera and the second camera over the network, the consumer transaction identifying module comprising a pre-processor module configured to save the one or more consumer transaction images of the one or more consumer transactions performed by the consumer in front of the display shelf, the pre-processor module configured to compare the one or more consumer transaction images and send the one or more consumer transaction images to a location finder module, whereby the location finder module configured to detect one or more hand positions from the one or more consumer transaction images captured by the first camera and the second camera and computes a physical location information of the one or more objects within the display shelf using a triangulation technique;
a direction detection module configured to identify a direction of motion of the hand from the one or more consumer transaction images, the direction detection module configured to enable a visual object detection module on the one or more consumer transaction images to detect the one or more objects in the hand and provides a selected list of one or more objects to the consumer; and
a central database configured to receive the first camera feed and the second camera feed captured by the first camera and the second camera during the one or more consumer transactions performed in front of the display shelf by the one or more consumers, the central database configured to hold an essential information of one or more objects, the central database configured to interact with the consumer transaction identifying module to display the selected list of objects along with quantities.

2. The system of claim 1, wherein the first camera is defined with one or more first camera regions of interests (RoIs).

3. The system of claim 1, wherein the second camera is defined with one or more second camera regions of interests (RoIs).

4. The system of claim 2, wherein the first camera region of interests comprising a first right marking region, a second right marking region.

5. The system of claim 3, wherein the second camera region of interests comprising a first left marking region, and a second left marking region.

6. The system of claim 4 and claim 5, wherein the first right marking region and the first left marking region are configured to monitor one or more hand movements during the consumer transactions of the one or more objects.

7. The system of claim 6, wherein the first right marking region and the first left marking region are configured to use the vicinity of a wrist to determine an approximate pixel location of the hand while picking up the one or more objects.

8. The system of claim 4 and claim 5, wherein the second right marking region and the second left marking region are configured to detect whether the one or more objects are picked from the display shelf or placed back in the display shelf.

9. The system of claim 1, wherein the consumer transaction identifying module comprising a pose estimation module configured to perform one or more pose estimations to determine the position of wrist while picking/placing the one or more objects.

10. The system of claim 1, wherein the triangulation technique configure to generate homographic transformation between calculated values and actual values to correct errors.

11. A method for detecting and analyzing consumer transactions to provide selected list of objects, comprising:
monitoring and capturing a first camera feed and a second camera feed by a first camera and a second camera, the first camera feed and the second camera feed comprising one or more consumer transaction images;
transmitting the first camera feed and the second camera feed captured from the first camera and the second camera to a computing device over a network;
saving the one or more consumer transaction images of the one or more consumer transactions by a pre-processor module;
comparing the one or more consumer transaction images by the pre-processor module and sending the one or more consumer transaction images to a location finder module;
detecting one or more hand positions from the one or more consumer transaction images by the location finder module and computing a physical location information of the hand within the display shelf using a triangulation technique;
enabling a visual object detection module on the one or more consumer transaction images to detect the one or more objects in the hand and providing a selected list of one or more objects to the consumer by the direction detection module;
identifying a direction of motion of the hand along with the physical location information of the hand from the one or more consumer transaction images by a direction detection module; and
saving the first camera feed and the second camera feed captured by the first camera and the second camera in a central database during the one or more consumer transactions performed in front of the display shelf by the one or more consumers.

12. The method of claim 11, further comprising a step of defining one or more first camera regions of interests (RoIs) by the first camera.

13. The method of claim 11, further comprising a step of defining one or more second camera regions of interests (RoIs) by the second camera.

14. The method of claim 11, further comprising a step of monitoring one or more hand movements during the consumer transactions of the one or more objects by a first right marking region and a first left marking region.

15. The method of claim 11, further comprising a step of determining an approximate pixel location of the hand while picking up the one or more objects using the vicinity of a wrist in the first right marking region and the first left marking region.

16. The method of claim 11, further comprising a step of detecting whether the one or more objects are picked from the display shelf or placed back in the display shelf using the second right marking region and the second left marking region.

17. The method of claim 11, further comprising a step of performing one or more pose estimations by a consumer transaction identifying module.

18. A computer program product comprising a non-transitory computer-readable medium having a computer-readable program code embodied therein to be executed by one or more processors, said program code including instructions to:
monitor and capture a first camera feed and a second camera feed by a first camera and a second camera, the first camera feed and the second camera feed comprising one or more consumer transaction images;
transmit the first camera feed and the second camera feed captured by the first camera and the second camera to a computing device over a network;
save the one or more consumer transaction images of the one or more consumer transactions by a pre-processor module;
compare the one or more consumer transaction images by the pre-processor module and send the one or more consumer transaction images to a location finder module;
detect or more hand positions from the one or more consumer transaction images by the location finder module and computing a physical location information of the hand within the display shelf using a triangulation technique;
enabling a visual object detection module on the one or more consumer transaction images to detect the one or more objects in the hand and providing a selected list of one or more objects to the consumer by the direction detection module;
identify a direction of motion of the hand along with the physical location information of the hand from the one or more consumer transaction images by a direction detection module; and
save the first camera feed and the second camera feed captured by the first camera and the second camera in a central database during the one or more consumer transactions performed in front of the display shelf by the one or more consumers.
